(19) United States
(12) Patent Application Publication
(10) Pub. No.: US 2004/0189129 A1
(43) Pub. Date: Sep. 30, 2004

(54) MAGNET CARRIER FOR ROTARY ELECTRICAL DEVICE

(75) Inventors: Hideaki Takahashi, Mori-machi (JP); Kazuyoshi Takagi, Mori-machi (JP)

Correspondence Address: ERNEST A. BEUTLER, ATTORNEY AT LAW, 10 RUE MARSEILLE, NEWPORT BEACH, CA, 92660, US

(73) Assignee: KABUSHIKI KAISHA MORIC, Mori-machi (JP)

(21) Appl. No.: 10/708,279

(22) Filed: Feb. 21, 2004

(30) Foreign Application Priority Data
Mar. 24, 2003 (JP) 2003-079365

(51) Int. Cl. H02K 21/12

(52) U.S. Cl. 310/156.19; 310/156.22

(57) ABSTRACT

A number of embodiments of magnet carriers for rotary electrical devices that eliminate the need for jigs or fixtures in the attachment of the permanent magnets in their slots. In addition several of the embodiments provide other manufacturing cost savings in eliminating the necessity of machining.

### BACKGROUND OF INVENTION

This invention relates to a magnet carrier for a rotary electrical device such as a motor or generator and more particularly to an improved construction therefore that eliminates the necessity for employing jigs or fixtures to locate the magnets when they are affixed to the carrier.

As is well known, rotary electrical devices such as motors or generators generally comprise relatively rotatable components one of which comprised an armature consisting of a plurality of ferromagnetic pole teeth around which are wound electrical coils. These cooperate with the other component that generally includes a cylindrical surface on which are mounted a plurality of permanent magnets. When the coils are sequentially energized, in the case of a motor, the relative rotation is effected. In the case of a generator the components are relatively rotated by a power source and electrical power may be extracted from the coil windings.

A typical construction of this type is illustrated in Published PCT Application WO 01/06617, published Jan. 25, 2001. With that type of device and with the prior art type of constructions, the permanent magnets have been positioned in circumferentially spaced, axially extending slots formed in the cylindrical surface of the carrying component in facing relation to the pole teeth around which the coils are wound.

A typical construction of the magnet carrier is shown in FIG. 1. Referring now to that figure, a rotor, indicated generally at 21, cooperates with the armature, which is not shown, and has a generally cylindrical surface 22 in which circumferentially spaced, axially extending slots 23 formed therein. These slots are relatively shallow and will receive plate type permanent magnets (not shown).

The rotor 21 has an axially extending opening 24 formed around its axis to receive a shaft which is driven in the case of a generator or which outputs power in the case of a motor. Generally this shaft carries a key for engagement in a keyway (not shown) formed at an area of the shaft hole 24 to rotatably couple the elements.

The magnets are normally affixed within the slots 23 by an adhesive or other bonding material. However, since the slots are open at both ends and the magnets should not extend axially beyond the rotor body 21, the magnets are positioned and located in a specially formed jig or fixture.

However when the adhesive or bonding agent is applied there is a likelihood that some of it will become deposited on the jig or fixture requiring cleaning.

It is therefore an object of this invention to provide an improved magnet carrier for a rotating electrical device that does not require either jigs or fixtures to locate the magnets during the bonding process.

### SUMMARY OF INVENTION

This invention is adapted to be embodied in a magnet carrier for a rotary electrical device comprised of a cylindrical body having an exposed cylindrical surface extending around a rotational axis of the device. A plurality of circumferentially spaced, axially extending slots are formed in the cylindrical surface of a depth sufficient to receive and contain a magnet element. These magnet element are positively located in the respective slot by a positioning member formed at at least one end of each of the slots and closing the end thereof to abuttingly engage an end of a magnet element received in the slot.

### BRIEF DESCRIPTION OF DRAWINGS

FIG. 1 is a perspective view of a prior art type of magnet carrier for a rotary electrical device.

FIG. 2 is a cross sectional view taken through a rotary electrical device of the type embodying the several described embodiments of the invention.

FIG. 3 is a side elevational view of a magnet carrier in accordance with a first illustrative embodiment of the invention.

FIG. 4 is an end elevational view looking in the direction of the arrows 4-4 in FIG. 3.

FIG. 5 is an end elevational view looking in the direction of the arrows 5-5 in FIG. 3.

FIG. 6 is a side elevational view, in part similar to FIG. 3, of a magnet carrier in accordance with a second illustrative embodiment of the invention.

FIG. 7 is an end elevational view looking in the direction of the arrows 7-7 in FIG. 6.

FIG. 8 is an end elevational view looking in the direction of the arrows 8-8 in FIG. 6.

FIG. 9 is a side elevational view, in part similar to FIGS. 3 and 6, of a magnet carrier in accordance with a third illustrative embodiment of the invention.

FIG. 10 is an end elevational view looking in the direction of the arrows 10-10 in FIG. 9.

FIG. 11 is an end elevational view looking in the direction of the arrows 11-11 in FIG. 9.

FIG. 12 is an exploded perspective view of the third embodiment.

FIG. 13 is a side elevational view, in part similar to FIGS. 3, 6 and 9, of a magnet carrier in accordance with a fourth illustrative embodiment of the invention.

FIG. 14 is an end elevational view looking in the direction of the arrows 14-14 in FIG. 13.

FIG. 15 is an end elevational view looking in the direction of the arrows 15-15 in FIG. 13.

FIG. 16 is an exploded perspective view of the fourth embodiment.

FIG. 17 is a perspective view of a magnet carrier in accordance with a fifth illustrative embodiment of the invention.

FIG. 18 is a perspective view, in part similar to FIG. 17, of a magnet carrier in accordance with a sixth illustrative embodiment of the invention.

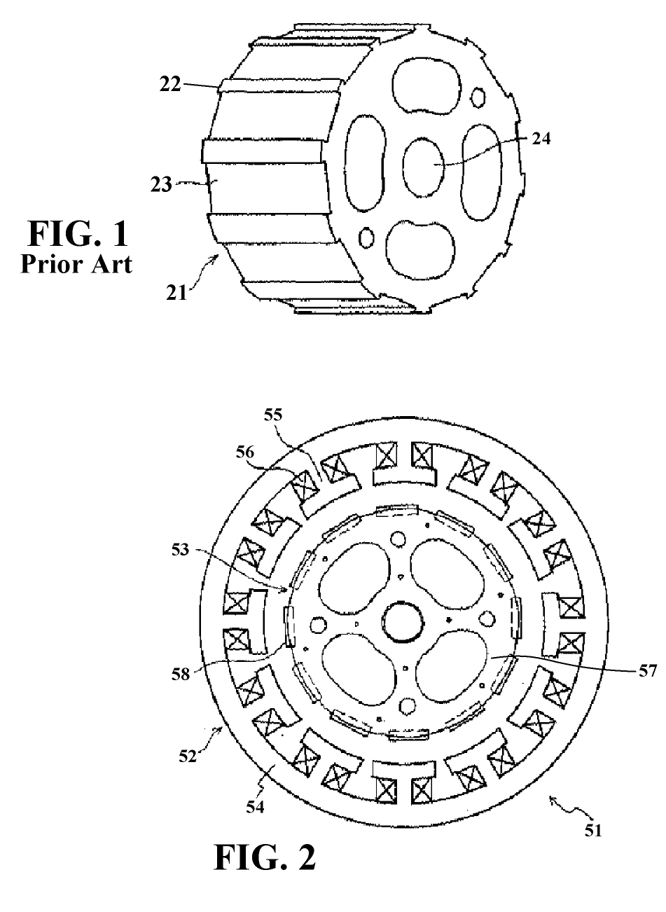

### DETAILED DESCRIPTION

Before describing in detail the various disclosed embodiments of magnet carriers for rotary electrical devices the overall construction of the environment in which the invention is employed by reference to FIG. 2. Those skilled in the art will readily understand that this description is only that of many types and device constructions in which the invention may be utilized.

A rotary electrical device of such a typical environment is indicated generally by the reference numeral 51 and may comprise an electric motor. The motor 51 is comprised of a stator consisting of an armature, indicated generally by the reference numeral 52. This stator 52 surrounds a rotor, which in this environment comprises a magnet carrier and assembly, indicated generally by the reference numeral 53.

The stator or armature 52 is comprised of a cylindrical core 54 from which a plurality of circumferentially spaced pole teeth 55 extend in a radially inward direction terminating in close proximity to the rotor 53. This core and pole teeth is conventionally formed from laminated ferro-magnetic sheets, although other constructions may be employed. Electrical coil windings 56 surround the pole teeth 55 and may be connected together in any desired manner.

The magnet carrier 53, which in the described arrangement comprises an inner rotor although those skilled in the art will readily understand that other constructions such as outer rotors or fixed inner or outer elements, is comprised of a magnet carrying body 57 that supports in manners to be described a plurality of circumferentially spaced permanent magnets 58. The reference numerals 57 and 58 will be utilized in describing each of the following embodiments with suffixes where desirable to distinguish between the various embodiments.

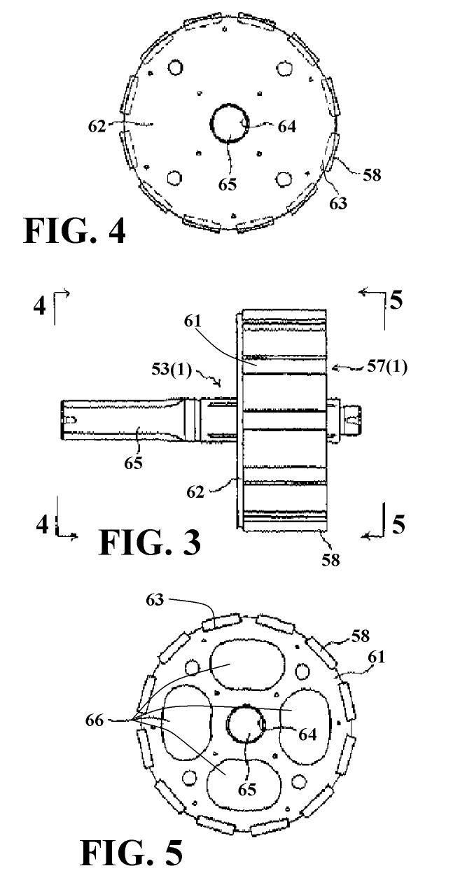

Referring now to the embodiment of FIGS. 3-5, the magnet carrier of this embodiment is identified generally by the reference numeral 53(1) and is comprised of a three piece body, identified generally by the reference numeral 37(1). This is in turn comprised of two pieces, a magnet carrier 61 and a magnet positioning plate 62. The magnet carrier, like the prior art, comprises a cylindrical body having a plurality of circumferentially spaced magnet receiving slots 63 in which the plate type permanent magnets 58 are received. The magnet carrier 61 may be formed from a single metallic body, or as will be described later, of a laminated construction. In this embodiment the slots 63 have a depth of about one half the thickness of the magnets.

As noted and like the prior art, the slots 63 extend completely through the carrier 61 and thus are open at both sides thereof. However the magnet positioning plate 62 closes these open ends at one side thereof (the left hand side in this embodiment). The outer diameter of the positioning plate can be any diameter greater that the diameter of the lower edges of the slots to as great as the diameter of the carrier 61 or even slightly greater than that diameter. Thus no other jig or fixture is required when the magnets are adhesively fixed in the slots 63.

The positioning plate 62 and magnet carrier 61 have aligned central holes 64 to receive a rotor shaft 65 to which they are nonrotatably affixed in any suitable manner. In addition at least the magnet carrier 61 is formed with a plurality of positioning holes 66 helping to fix the core for magnetization of the plates 58 after they are attached thereto. The positioning hole 15 for magnetization alignment need not be provided in the positioning plate 62.

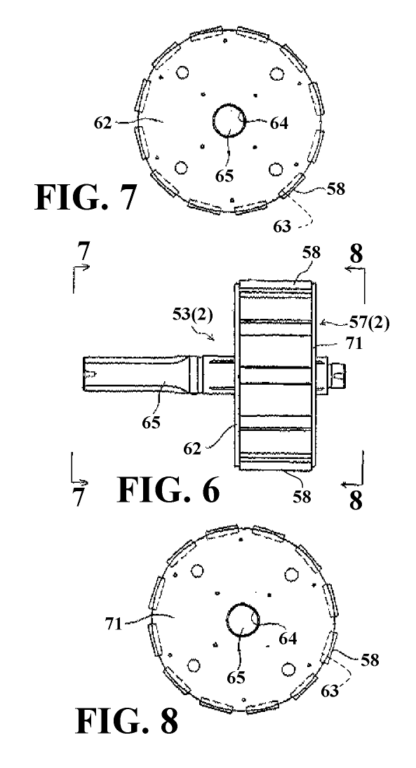

FIGS. 6-8 show another embodiment which is generally similar to that of FIGS. 3-5 and in which the magnet carrier is indicated generally by the reference numeral 53(2) and which includes a three piece body 57(2). Two of the pieces are of the same construction as the previously described embodiment and have been identified by the same reference numerals here. These comprise a magnet carrier 61 and a magnet positioning plate 62. In addition a second positioning plate 71 is fixed to the side of the magnet carrier 61 opposite to the positioning plate 62. The positioning plates 62 and 71 can have the same construction and it is believed that further description of this embodiment is not required.

It has been previously noted that the magnet carrier, although shown in the already described embodiments as being formed from a single piece could be of a laminated construction. Next will be described two embodiments (those of FIGS. 9-12 and FIGS. 13-6) where such laminated constructions.

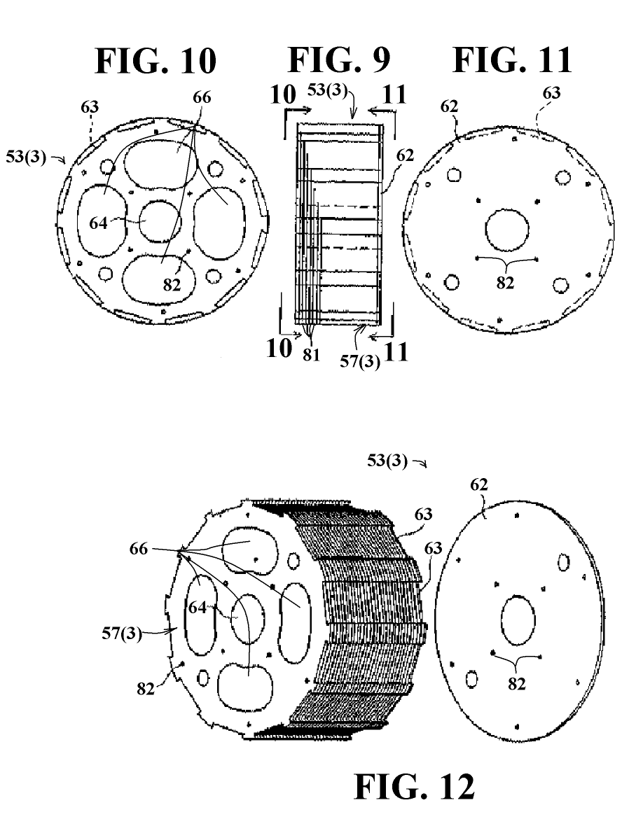

Referring first to the embodiment of FIGS. 9-12, this embodiment is the same as that of FIGS. 3-5 except for this difference. Also in these views the magnets 58 are not shown as they are the same as in the previous embodiments. Thus like components are identified by like reference numerals.

The magnet carrier assembly is indicated generally by the reference numeral 53(3) and its body is designated by the reference numeral 57(3). Also it should be noted that the positioning plate 62 is positioned at the opposite side of the main body portion 57(3) from the previously described embodiment.

In this embodiment, as already mentioned, the main body portion 57(3) is formed from a plurality of stacked, thin metal sheets 81, which may be formed by stamping. Aside from this, it is believed that further discussion of the embodiment is necessary except to state that the sheets 81 and positioning plate 62 may be stamped using the same dies and the magnet holding recesses may be formed either by machining after the pressing operation or the by performing an additional stamping operation on them. In addition all plates are stamped with indentations 82 to facilitate their alignment.

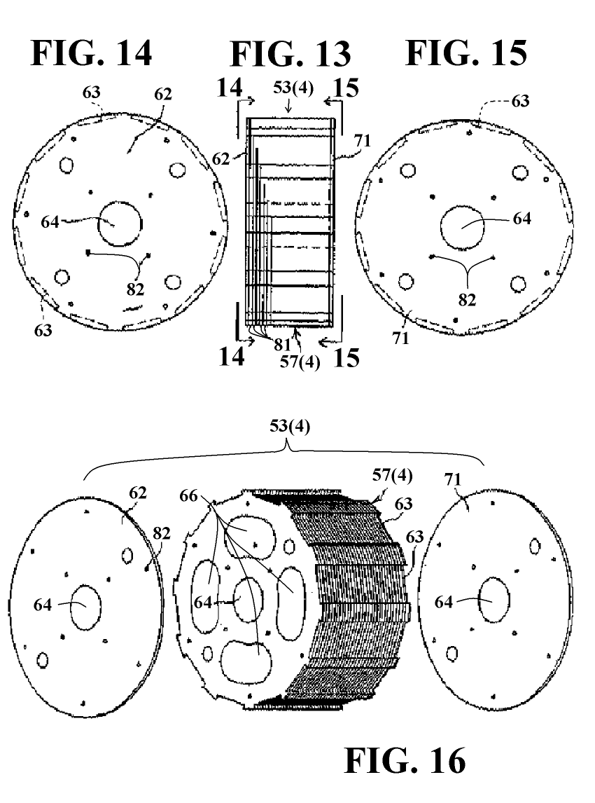

Referring now to the embodiment of FIGS. 13-16, this embodiment is the same as that of FIGS. 6-8 except for the lamination of the magnet body, to be described shortly. Also in these views the magnets 58 are not shown as they are the same as in the previous embodiments. Thus like components of this embodiment and those of FIGS. 6-8 and 9-12 are identified by like reference numerals.

The magnet carrier assembly is indicated generally by the reference numeral 53(4) and its body is designated by the reference numeral 57(4). In this embodiment, as already mentioned, the main body portion 57(4) is formed from a plurality of stacked, thin metal sheets 81, which may be formed by stamping. Aside from this, it is believed that further discussion of the embodiment is necessary except to state that the sheets 81 and positioning plates 62 and 71 may be stamped using the same dies and the magnet holding recesses may be formed either by machining after the pressing operation or the by performing an additional stamping operation on them. In addition all plates are stamped with the indentations 82 to facilitate their alignment.

In all of the embodiments thus far described the magnet carrier and the positioning plates have been separate elements and in some embodiments the magnet carrier itself has been of a laminated construction. These embodiments all achieve the desired results of eliminating the necessity of jigs or fixtures to assemble the magnets to the magnet carrier and reduce the cost not only of assemble but also of manufacture. Next will be described two embodiments that eliminate the need for jigs or fixtures, but which require machining operations to achieve the other desired result.

In these embodiments the magnet positioning is achieved by forming an integral wall that closes one or both ends of the slots to perform the magnet positioning function.

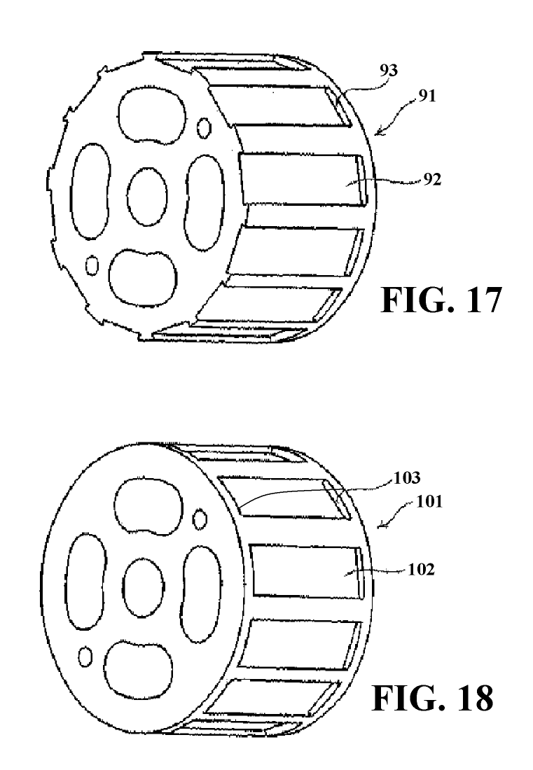

Referring first to the embodiment of FIG. 17, this produces a magnet carrier, indicated generally by the reference numeral 91 that resembles the arrangement of FIGS. 3-5 and 9-12. As will be seen, the carrier 91 is formed as a single piece having circumferentially spaced, axially extending slots 92. These slots extend from one axial end of the carrier but terminate short of the other end to leave positioning walls 93 that serve to position the plate type magnets during their bonding or adhesive attachment.

The embodiment of FIG. 18 is similar in end result to the embodiments of FIGS. 6-8 and 13-16 but like the embodiment of FIG. 17 requires a machining operation. The carrier of this embodiment is indicated generally by the reference numeral 101 and has circumferentially spaced, axially extending slots 102 machined in its cylindrical outer surface. These slots terminate short of both axial ends of the carrier 101 and thus leave positioning walls 103 at each end thereof.

Thus from the foregoing description, it should be readily apparent that all of the embodiments described eliminate the need for jigs or fixtures in the attachment of the permanent magnets in their slots. In addition several of the embodiments provide other manufacturing cost savings in eliminating the necessity of machining. Of course those skilled in the art will readily understand that the described embodiments are only exemplary of forms that the invention may take and that various changes and modifications may be made without departing from the spirit and scope of the invention, as defined by the appended claims.

1. A magnet carrier for a rotary electrical device comprised of a cylindrical body having an exposed cylindrical surface extending around a rotational axis of the device, a plurality of circumferentially spaced, axially extending slots formed in said cylindrical surface of a depth sufficient to receive and contain a magnet element, and a positioning member formed at at least one end of each of said slots and closing the end thereof to abuttingly engage an end of a magnet element received in said slot for positively locating the magnet element in the respective slot.

2. A magnet carrier for a rotary electrical device as set forth in claim 1, wherein a positioning member is provided at only one end of each slot.

3. A magnet carrier for a rotary electrical device as set forth in claim 2, wherein the positioning members are all positioned at the same axial end of the slots.

4. A magnet carrier for a rotary electrical device as set forth in claim 3, wherein the slots are all formed in a cylindrical surface formed by a common element.

5. A magnet carrier for a rotary electrical device as set forth in claim 4, wherein the positioning members are all formed from a common element.

6. A magnet carrier for a rotary electrical device as set forth in claim 5, wherein common elements forming the slots and the positioning members are the same.

7. A magnet carrier for a rotary electrical device as set forth in claim 3, wherein the slots are formed by a plurality of laminated plates.

8. A magnet carrier for a rotary electrical device as set forth in claim 8, wherein the positioning members are all formed from a common plate fixed at one end of the laminated plates.

9. A magnet carrier for a rotary electrical device as set forth in claim 1, wherein a positioning member is provided at each end of each slot.

10. A magnet carrier for a rotary electrical device as set forth in claim 4, wherein the positioning members at the respective ends of the slots are all formed from a common element.

11. A magnet carrier for a rotary electrical device as set forth in claim 10, wherein common elements forming the slots and the positioning members are the same.

12. A magnet carrier for a rotary electrical device as set forth in claim 9, wherein the slots are formed by a plurality of laminated plates.

13. A magnet carrier for a rotary electrical device as set forth in claim 12, wherein the positioning members at each end of the slots are all formed from a common plate fixed at the respective end of the laminated plates.
